(19) United States
(12) Patent Application Publication
(10) Pub. No.: US 2015/0312574 A1
(43) Pub. Date: Oct. 29, 2015

(54) TECHNIQUES FOR LOW POWER IMAGE COMPRESSION AND DISPLAY

(71) Applicant: INTEL CORPORATION, SANTA CLARA, CA (US)

(72) Inventors: Zhiwei YING, Shanghai (CN); Changliang WANG, Bellevue, WA (US)

(21) Appl. No.: 14/128,612

(22) PCT Filed: Aug. 12, 2013
(86) PCT No.: PCT/CN2013/081275

§ 371 Date: Dec. 22, 2013

(51) Int. Cl. H04N 19/156; G09G 3/20; H04N 19/147; G09G 5/00; H04N 19/14; H04N 19/105

(52) U.S. Cl. CPC H04N 19/156; H04N 19/14; H04N 19/105; H04N 19/147; G09G 5/001; G09G 3/2003; G09G 2310/04; G09G 2320/103; G09G 2330/021; G09G 2360/08; G09G 2360/18

(57) ABSTRACT

Various embodiments are generally directed to techniques for reducing the consumption of electric power in rendering an image onto a display associated with a computing device by generating and compressing difference frames for use in rendering the image. A device to compress video frames includes a processor component; and a frame buffer compressor for execution by the processor component to compress a current frame of a series of frames as a compressed difference frame, the compressed difference frame comprising a difference frame that indicates a difference in pixel color of at least one pixel between the current frame and a preceding adjacent frame of the series of frames. Other embodiments are described and claimed.

### CROSS-REFERENCE TO RELATED APPLICATION

Attention is drawn to a subject-matter related application filed concurrently herewith by the inventors named herein, entitled TECHNIQUES FOR LOW POWER VIDEO COMPRESSION AND TRANSMISSION (attorney docket number P55776PCT).

### TECHNICAL FIELD

Embodiments described herein generally relate to reducing power consumption in compressing and visually presenting images.

### BACKGROUND

Raster scan rendering of an image onto a display of a computing device is typically performed 30 to as much as 85 times a second as the display is refreshed. This results in the data that makes up that image being fully retrieved from a storage 30 to as much as 85 times every second, regardless of whether any portion of the image has changed. Each such recurring access to a storage to retrieve the data of an image and the accompanying recurring transmission of that data through one or more busses to convey it from the storage to a display device consumes a considerable amount of electric power. This can become a significant issue where the storage is of a portable computing device relying upon a battery for the electric power to perform such calculations.

An approach to reducing such electric power consumption is compressing the image in the storage to reduce the overall amount of data recurringly retrieved and conveyed for each display refresh. Although this achieves some degree of reduction in electric power consumption, compressing an entire image also entails accesses to the storage and is processor-intensive such that a considerable amount of electric power is still consumed.

Another approach entails providing the display with its own display buffer to store a copy of the image that is visually presented on the display. In instances where there are no changes to the image, the display may be signaled to refresh its visual presentation of the image from that display buffer such that the recurring retrieving and conveying of the image from the storage may be avoided, at least until a change in the image occurs. This approach reduces electric power consumption during periods where changes to the image are infrequent. However, this approach cannot be used where the image includes playback of motion video where there are frequent and significant ongoing changes to the image.

### BRIEF DESCRIPTION OF THE DRAWINGS

FIG. 1 illustrates an embodiment of a video presentation system.

FIG. 2 illustrates an alternate embodiment of a video presentation system.

FIG. 3 illustrates an example of a degree of change between two adjacent frames that include motion video.

FIG. 4 illustrates an example of a degree of change between two adjacent frames that do not include motion video.

FIGS. 5-6 each illustrate a portion of an embodiment of a video presentation system.

FIGS. 7-8 each illustrate a portion of an alternate embodiment of a video presentation system.

FIGS. 9-12 each illustrate a logic flow according to an embodiment.

FIG. 13 illustrates a processing architecture according to an embodiment.

FIG. 14 illustrates another alternate embodiment of a graphics processing system.

FIG. 15 illustrates an embodiment of a device.

### DETAILED DESCRIPTION

Various embodiments are generally directed to techniques for reducing the consumption of electric power in rendering an image onto a display associated with a computing device by generating and compressing difference frames for use in rendering the image. The difference frames represent differences in pixel color values between a current frame of the image and a preceding adjacent frame. Thus, a current frame is described in terms of its per-pixel differences in color values from the preceding adjacent frame, and it is this description of differences in the form of a difference frame that is compressed and stored, rather than the current frame itself.

The image visually presented on the display of the display device must be refreshed with a recurring raster scan rendering of the image onto the display. During normal operation of the computing device, the recurring refreshing of the image on the display entails recurring accesses to the storage of the computing device to retrieve the image and recurring use of one or more busses of the computing device to convey the image to the display device. Given that it is usually possible to describe the differences in pixel color values of one frame from the pixel color values of another adjacent frame with less data than is usually required to describe the pixel values of a frame without reference to another frame, it is envisioned that the amount of data recurringly retrieved from the storage and conveyed to the display device for each refresh is substantially reduced through the use of difference frames, thereby conserving electric power. This reduction in data size already achieved through the generation and use of difference frames also enables the use of a less aggressive type of compression that does not require processor-intensive calculations that would consume considerable amounts of electric power.

However, the provision of frames to the display device does not begin with the provision of a difference frame. Following an event that results in there being no previous frame to serve as a reference for a difference frame, the first frame retrieved from the storage and provided to the display device is a full frame that describes an image without reference to any other frame. Events that may lead to there being no previous frame to use as a reference include powering on of the computing device, a return of the computing device to a normal operating state from a low power state in which no image was displayed, or a resetting of the computing device. Such provision of a full frame that describes an image to the display device is necessary for the display device to have an initial state of the pixels of the image for the first of the difference frames to make reference to.

The portion of the storage in which at least the compressed difference frames are stored and from which they are recurringly retrieved may be a compressed frame buffer defined within a larger storage also employed for other purposes. Alternatively, a specific portion of the storage that may be made up of specific storage devices may be selected to serve as the compressed frame buffer into which the compressed difference frames are stored and from which they are recurringly retrieved (e.g., multi-port dynamic random access memory devices).

In some embodiments, the display device may be physically incorporated into the computing device. In such embodiments, portions of the display device may be addressable by a processor component of the computing device (e.g., storage locations of a storage of the display device may be so addressable). In other embodiments, the display device may be physically separate from the computing device, but coupled to the computing device to enable receipt of full and difference frames therefrom.

Regardless of whether the display device is integrated into the computing device or merely coupled to it, the display device receives the difference frames and reconstructs the current frame to be visually presented. Reconstruction may be performed simply by summing the differences in pixel values described in the most recent difference frame and the pixel values of the last frame to be reconstructed and visually presented. The display device maintains the last frame to be reconstructed and visually presented in its own storage. In response to instances of there being no difference between adjacent frames (or in response to the differences between adjacent frames being less than a selected threshold of difference), the computing device may signal the display device to autonomously refresh the image it visually presents from its own storage. As the display device does so, the computing device ceases the recurring retrieval and conveying of difference frames at least until there is later a change in the image.

The image visually presented on the display of the display device may or may not include motion video. In some embodiments where motion video is included, such motion video may be received from another computing device and/or stored within the computing device in compressed form. The motion video may have been compressed using any of a wide variety of types of compression including and not limited to a version of the Motion Picture Experts Group (MPEG) specification promulgated by the International Organization for Standardization of Geneva, Switzerland. Where the motion video is compressed, the computing device decompresses it using an appropriate decoder to generate uncompressed frames of the motion video that may be included in the image. Full and difference frames are then generated from the uncompressed frames.

In other embodiments in which the motion video is compressed in accordance with a version of MPEG, the computing device may decompress the motion video up to the point of deriving difference frames and accompanying indications of motion vectors employed in describing shifts in locations of pixel color values of blocks of pixels. The computing device then compresses these difference frames and may also compress the indications of motion vectors. Upon being retrieved and conveyed to the display device, the indications of motion vectors are conveyed along with the difference frames. The display device then combines the difference frames with the indications of motion vectors to complete the decompression of the motion video and reconstruct its frames for visual presentation on the display.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

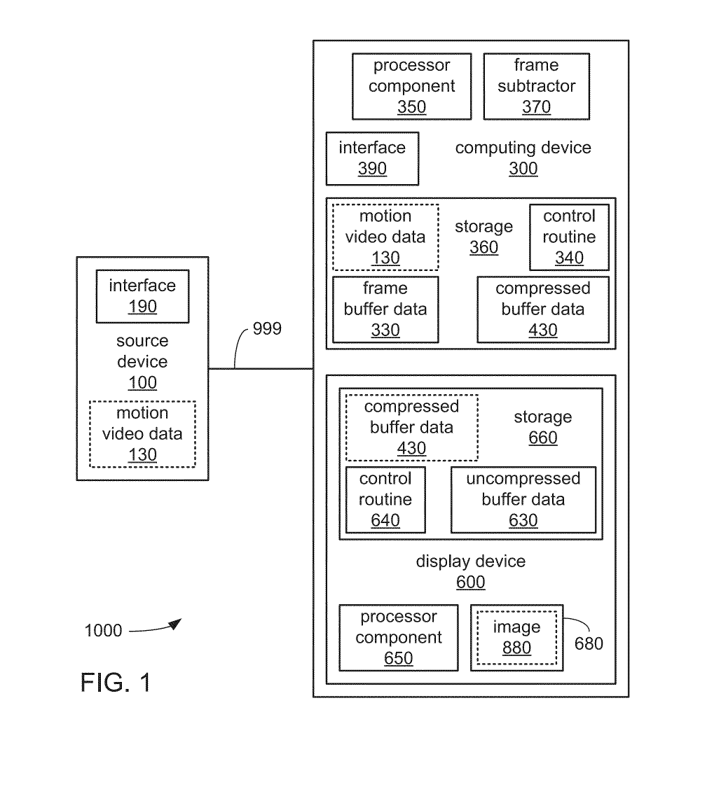

FIG. 1 illustrates a block diagram of an embodiment of a video presentation system 1000 incorporating one or more of a source device 100 and a computing device 300 incorporating a display device 600. In the video presentation system 1000, frames of a changing image 880 are compressed by the computing device 300 and are then recurringly provided to the display device 600 to be visually presented on a display 680. Each of the computing devices 100 and 300 may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc.

As depicted, these computing devices 100 and 300 may exchange signals conveying compressed frames representing visual imagery and/or related data through a network 999. However, one or both of these computing devices may exchange other data entirely unrelated to visual imagery with each other and/or with still other computing devices (not shown) via the network 999. In various embodiments, the network may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, the source device 100 (if present) incorporates an interface 190 to couple the source device 100 to the computing device 300 to provide the computing device 300 with frames of a motion video data 130. These frames may be provided to the computing device 300 in compressed form employing any of a variety of compression techniques familiar to those skilled in the art, including and not limited to a version of MPEG.

In various embodiments, the computing device 300 incorporates one or more of a processor component 350, a storage 360, a frame subtractor 370, the display device 600 and an interface 390 to couple the computing device 300 to the network 999. The storage 360 stores one or more of the motion video data 130, a frame buffer data 330, a compressed buffer data 430 and a control routine 340.

The control routine 340 incorporates a sequence of instructions operative on the processor component 350 in its role as a main processor component of the computing device 300 to implement logic to perform various functions. In executing the control routine 340, the processor component 350 subtracts the color values of corresponding pixels of adjacent frames of the frame buffer data 330 to derive difference frames. More specifically, each pixel of a current frame of the frame buffer data 330 is subtracted from the color values of each corresponding pixel of the preceding adjacent frame (the frame that immediately precedes the current frame) of the frame buffer data 330, or vice versa, to derive a difference frame of differences in pixel color values between those two frames. Since this is done for every pair of adjacent frames (adjacent in time) of the frame buffer data 330, the current frame in one such subtraction becomes the preceding adjacent frame in the next such subtraction. In some embodiments, such subtraction may be performed by the frame subtractor 370 implemented with digital circuitry to enable speedy performance of such subtraction. In other embodiments, such subtraction may be caused by the control routine 340 to be performed by the processor component 350.

Regardless of the exact manner in which the subtraction is performed to derive each difference frame, the processor component 350 then compresses each difference frame before storing the compressed difference frames as part of the compressed buffer data 430. In some embodiments, the processor component 350 employs Huffman coding to compress the difference frames. However, other types of compression may occur to those skilled in the art. In support of the refreshing the image 880 visually presented on the display 680, the processor component 350 recurringly retrieves the compressed difference frames of the compressed buffer data 430, and provides those compressed difference frames to the display device 600.

In various embodiments, the display device 600 incorporates one or more of a processor component 650, a storage 660 and the display 680. The storage 660 stores one or more of the frames of the compressed buffer data 430 as received from the computing device 300, an uncompressed buffer data 630 and a control routine 640.

The control routine 640 incorporates a sequence of instructions operative on the processor component 650 in its role as a main processor component of the display device 600 to implement logic to perform various functions. In executing the control routine 640, the processor component 650 decompresses the compressed difference frames of the compressed buffer data 430 stored in the storage 660, and stores the resulting uncompressed difference frames as part of the uncompressed buffer data 630. The processor component 650 then sums the most recently received of the uncompressed difference frames with the last frame to be reconstructed and visually presented to reconstruct the newest frame to be visually presented on the display 680.

The uncompressed frames of the frame buffer data 330 from which the difference frames are derived may represent imagery that is generated by the processor component 330. Such frames may include a visual portion of a user interface that may include menus, visual representations of data, a visual representation of a current position of a pointer, etc. Such a visual portion of a user interface may be associated with an operating system of the computing device 300 and/or an application routine (not shown) executed by the processor component 350.

Alternatively or additionally, the uncompressed frames of the frame buffer data 330 may include motion video frames from the motion video data 130. The frames of the motion video data 130 may be received by the computing device 300 from another computing device such as the source device 100, or may be generated by the computing device 300 itself. Regardless of whether the frames of the motion video data 130 are received and/or generated within the computing device 300, they may be stored in the storage 360 in compressed form. If so, then those frames may have been compressed employing any of a variety of types of compression, including and not limited to a version of MPEG. The processor component 350 may decompress the frames of the motion video data 130 using an appropriate type of decompression and store the resulting decompressed frames as part of the frame buffer data 330 for visual presentation on the display 680. Then, just as would be done with uncompressed frames in the frame buffer data 330 that do not include motion video, the processor component 350 recompresses the decompressed frames of the video data 130 for storage as part of the compressed buffer data 430 in preparation for retrieval and conveyance to the display device 600. As previously discussed, Huffman coding may be employed in compressing frames stored in the frame buffer data 330. Thus, in some embodiments, frames of the motion video data 130 that may have been compressed using a version of MPEG may first be decompressed for storage in the frame buffer data 330 and then compressed again using Huffman coding for storage in the compressed buffer data 430 for recurring retrieval and conveyance to the display device 600 in synchronization with the refreshing of the display 680.

In alternate embodiments where the frames of the motion video data 130 are compressed using a version of MPEG or similar compression technique, the processor component 350 may only partly decompress them for storage in the frame buffer data 330. More specifically, the processor component 350 may decompress the frames of the motion video data 130 only to the extent needed to derive difference frames and indications of accompanying motion vectors that describe the direction and distance that one or more blocks of pixel color values have shifted between adjacent frames. These difference frames and indications of their associated motion vectors may then be stored by the processor component 350 in the frame buffer data 330. The processor component 350 then recompresses these difference frames and stores them in their compressed form in the storage 360 as part of the compressed buffer data 430. Again, in some embodiments, Huffman coding may be employed in compressing these difference frames. The processor component 350 may or may not also compress the associated indications of motion vectors before storing the indications of motion vectors as part of the compressed buffer data 430 in the storage 360.

In these alternate embodiments, support of refreshing of the image 880 on the display 680 entails the processor component 350 recurringly retrieving both compressed difference frames and associated indications of motion vectors from the compressed buffer data 430 of the storage 330 and conveying them to the display device 600. The processor component 650 of the display device 600 receives these compressed difference frames and indications of motion vectors and stores them as part of the compressed buffer data 430 within the storage 660. The processor component 650 then decompresses these difference frames employing an appropriate decompression technique (e.g., decompression with Huffman coding), storing them as part of the uncompressed buffer data 630. Where the indications of the motion vectors are also compressed, the processor component 650 also decompresses those indications and also stores them as part of the uncompressed buffer data 630. The processor component 650 then completes the MPEG-based decompression of the difference frames by combining them with their associated motion vectors to reconstruct the frames of the motion video data 130 in fully decompressed form, including the next frame to be visually presented on the display 680.

In essence, in these various embodiments, the portion of the storage 360 in which the compressed buffer data 430 is maintained is employed as a compressed frame buffer. This portion of the storage 360 may be a portion of the storage that is simply defined by specification of an address range to be a compressed frame buffer. Or, this portion of the storage 360 may be made up of storage components substantially dedicated to serving as a frame buffer, including a compressed frame buffer. It should be noted that such a portion may also be configured to include the uncompressed frame buffer data 330, in addition to the compressed buffer data 430.

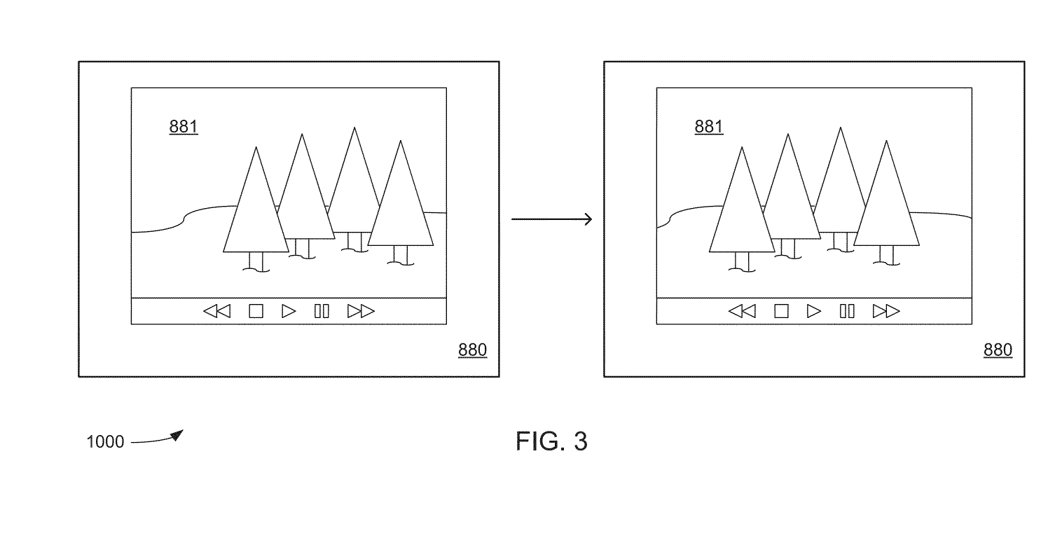

As previously discussed, it is envisioned that the image 880 visually presented on the display 680 may include either imagery generated by the computing device 300 (e.g., a visual portion of a user interface) or motion video imagery (e.g., motion video captured with a camera). As familiar to those skilled in the art, motion video imagery tends to include a higher degree of change in pixel color values between adjacent frames than the computer-generated imagery typical of visual portions of user interfaces. FIG. 3 illustrates a degree of change between an example of a pair of adjacent frames of the image 880 in which motion video is included. As can be seen in the transition from one adjacent frame to another, there is panning of motion video 881 captured by a motion video camera in which a stand of trees and surrounding terrain are caused to shift position. As can also be seen, the visual presentation of the stand of trees and surrounding terrain occupies a significant number of the pixels of the visual imagery 880 such that the shifting of these objects due to panning changes the state of a great many pixels. As a result, it is likely that there is a high degree of difference therebetween.

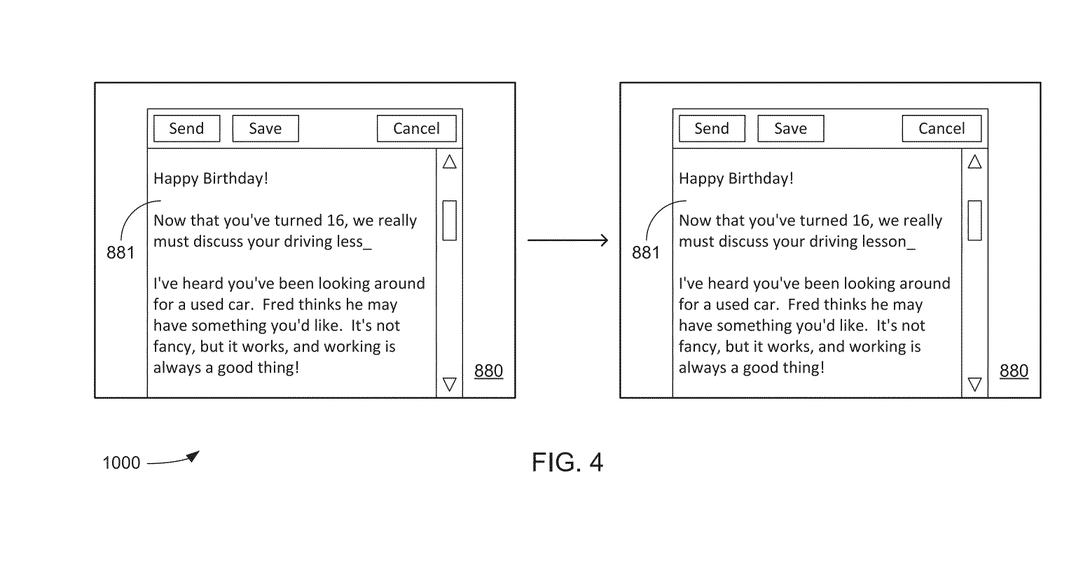

FIG. 4 illustrates a degree of change between an example of another pair of adjacent frames of the image 880 in which no motion video is included. In contrast to the example of FIG. 3., the image 880 in the example of FIG. 4 is substantially occupied with a visual portion of a user interface of an example email text editing application. As can be seen in the transition from one adjacent frame to another, the typing of a line of text in the depicted email progresses only as far as adding the characters “on” to the characters “less” as part of the entry of the word “lessons” in this example. As can also be seen, this addition of two text characters in this progression from one adjacent frame to another affects relatively few pixels as all of the rest of what is visually presented remains unchanged. Given that refresh rates for displays are typically 30 to 85 frames per second, it is envisioned that only a relatively low degree of change is to be expected between adjacent frames during much of the time a visual portion of a user interface is visually presented as there are biomechanical limits to how quickly text or other input can be provided to the computing device 300. Indeed, where an operator of the computing device 300 pauses in providing input to read text or otherwise view a visual portion of a user interface, it is envisioned as likely that significant numbers of successive adjacent frames may have no differences whatsoever between them. Thus, although the use and compression of difference frames for storage as the compressed buffer data 430 is envisioned as achieving a considerable reduction in the amount of data to be recurringly retrieved and provided to the display device, it is likely that the amount of data is greater where the difference frames include motion video.

Returning to FIG. 1, as previously discussed, there may be occasions in which a full frame describing the state of the image 880 without reference to a previous frame must be provided to the display device 600. Again, this may be necessary following an event such as powering up of the computing device 300, a resetting of the computing device 300 or another circumstance that results in there being no previous frame available for a difference frame to refer to. Further, in some embodiments, it may be deemed desirable to provide a full frame in lieu of a difference frame where there has been a significant change in the image 880 such that the pixel color values of a significant proportion of the pixels change between a current frame and a preceding adjacent frame to a significant degree. In some embodiments, each derived difference frame may be analyzed to determine a degree of difference, and a full frame may be compressed and provided to the display device 600 in lieu of a difference frame where the degree of difference exceeds a threshold. Regardless of the reason for compression and storage of a full frame versus a difference frame, the processor component 350 may compress both using the same type of compression (e.g., Huffman coding). Further, the processor component 350 may store both full frames and difference frames in compressed form in the compressed buffer data 430 to be retrieved and conveyed to the display device 600. In conveying either of a full frame or a difference frame to the display device 600, the processor component 350 may additionally provide an indication of which type of frame is being conveyed. In some embodiments, such an indication may be embedded in the conveyed frames, themselves.

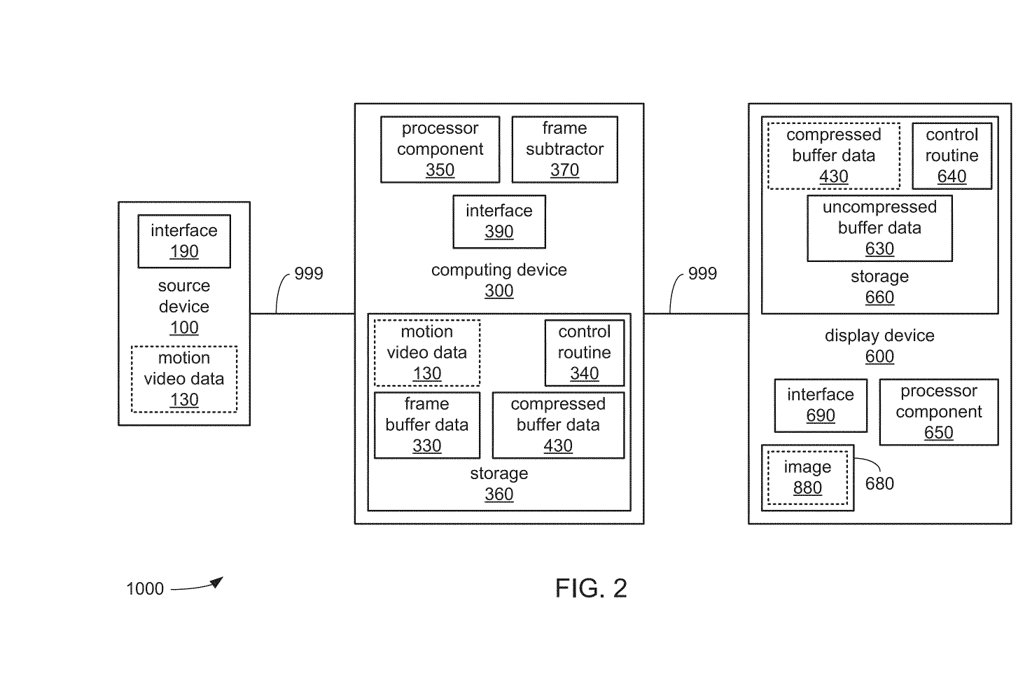

FIG. 2 illustrates a block diagram of an alternate embodiment of the video presentation system 1000 that includes an alternate embodiment of the computing device 300. The alternate embodiment of the video presentation system 1000 of FIG. 2 is similar to the embodiment of FIG. 1 in many ways, and thus, like reference numerals are used to refer to like elements throughout. However, unlike the computing device 300 of FIG. 1, the computing device 300 of FIG. 2 does not incorporate the display device 600. Also, unlike the display device 600 of FIG. 1, the display device 600 of FIG. 2 may incorporate an interface 690 to couple the display device 600 to the computing device 300 via the network 999 and/or via a different linkage. Thus, in the alternate embodiment of the video presentation system 1000 of FIG. 2, the processor component 350 may transmit the compressed frames retrieved from the compressed frame buffer 430 stored in the storage 360 to the display device 600 via a network.

In various embodiments, each of the processor components 350 and 650 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

Although each of the processor components 350 and 650 may include any of a variety of types of processor, it is envisioned that the processor component 650 of the display device 600 may be somewhat specialized and/or optimized to perform tasks related to graphics and/or video. More broadly, it is envisioned that the display device 600 embodies a graphics subsystem of the computing device 300 to enable the performance of tasks related to graphics rendering, video compression, image resealing, etc., using components separate and distinct from the processor component 350 and its more closely related components.

In various embodiments, each of the storages 360 and 660 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the interfaces 190, 390 and 690 may employ any of a wide variety of signaling technologies enabling these computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

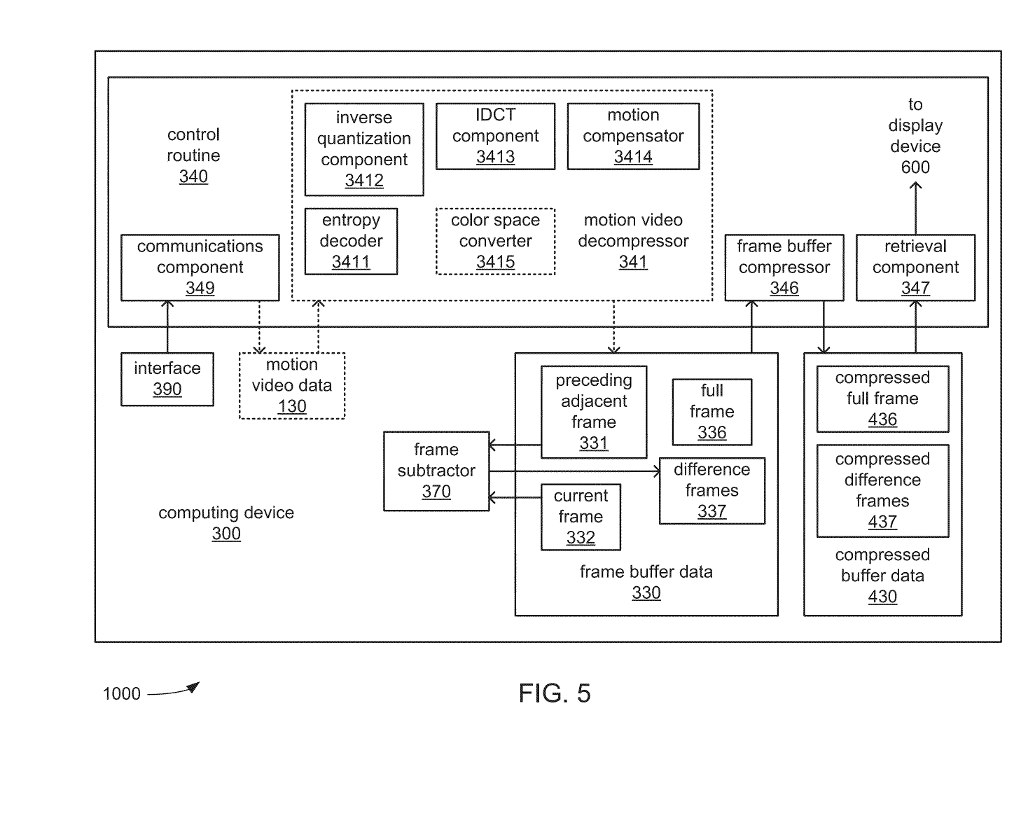

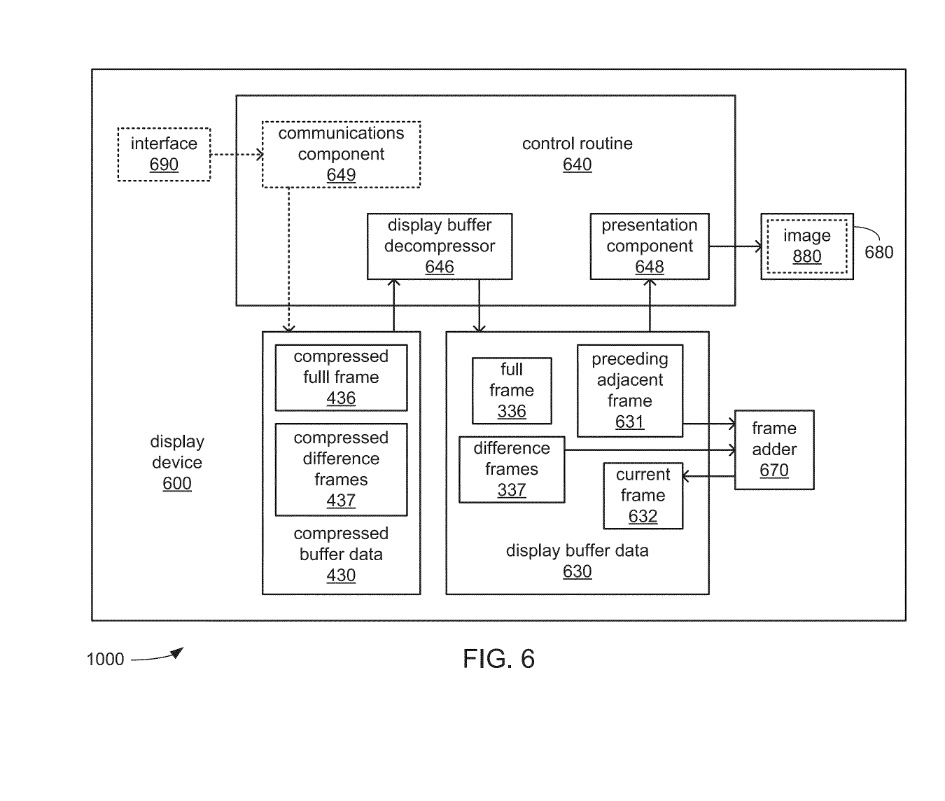

FIGS. 5 and 6 each illustrate a block diagram of a portion of an embodiment of the video presentation system 1000 of either of FIG. 1 or 2 in greater detail. More specifically, FIG. 5 depicts aspects of the operating environment of the computing device 300 in which the processor component 350, in executing the control routine 340, compresses and stores frames of the image 880 for later recurring retrieval and provision to the display device 600. FIG. 6 depicts aspects of the operating environment of the display device 600 in which the processor component 650, in executing the control routine 640, decompresses and visually presents those frames on the display 680. As recognizable to those skilled in the art, the control routines 340 and 640, including the components of which each is composed, are selected to be operative on whatever type of processor or processors that are selected to implement the processor components 350 and 650, respectively.

In various embodiments, each of the control routines 340 and 640 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for corresponding ones of the processor components 350 or 650. Where one or more device drivers are included, those device drivers may provide support for any of a variety of other components, whether hardware or software components, of corresponding ones of the computing devices 300 or 600.

The control routine 340 may include a communications component 349 executable by the processor component 350 to operate the interface 390 to transmit and receive signals via the network 999 as has been described. Among the signals received may be signals conveying the motion video data 130 to the computing device 300 via the network 999. As will be recognized by those skilled in the art, this communications component is selected to be operable with whatever type of interface technology is selected to implement the interface 390.

Turning more specifically to FIG. 5, the control routine 340 includes a frame buffer compressor 346 executable by the processor component 350 to compress a full frame 336 and/or difference frames 337 of the frame buffer data 330 to generate a compressed full frame 436 and/or compressed difference frames 437, respectively, of the compressed buffer data 430. As previously explained, there may be circumstances that result in there being no previous frame for a difference frame 337 to refer to in describing pixel color values as differences from a previous frame, or where it is deemed desirable to send a full frame 336 regardless of there being a previous frame that a difference frame could refer to. Therefore, the need may occasionally arise for the frame buffer compressor 346 to compress a full frame 336, instead. Following compression of the full frame 336, the full frame 336 then becomes the preceding adjacent frame 331 referred to by the first one of the difference frames 337 that follows the full frame 336 to describe the first one of the current frames 332 that follows the full frame 336. As has been discussed, the frame buffer compressor 346 may implement Huffman coding in some embodiments.

As depicted, and as previously discussed, the difference frames 337 may be derived by the frame subtractor 370 made up of digital circuitry in some embodiments to increase the speed at which the differences in pixel color values are calculated. However, in other embodiments, the processor component 350 may execute a component of the control routine 340 that causes the processor component 350 to perform such difference calculations.

The control routine 340 includes a retrieval component 347 executable by the processor component 350 to support refreshing the image 880 visually presented on the display 680 by recurringly retrieving the most recent compressed frame from the compressed buffer data 430 and providing it to the display device 600. As has been discussed, it is usually compressed difference frames 437 that are retrieved from the compressed buffer data 430. However, following circumstances in which a full frame must be provided to display device 600, the retrieval component 347 retrieves the compressed full frame 436 and provides it to the display device 600.

Thus, in the operating environment depicted in FIG. 5, frames of a visual component of a user interface generated by the computing device 300 are first employed to generate multiple difference frames 337 by the frame subtractor 370, which are stored in the frame buffer data 330. Then, at least one full frame 336 and multiple difference frames 337 representing the frames of the visual portion of the user interface are compressed by the frame buffer compressor 346. The resulting at least one compressed full frame 436 and multiple compressed difference frames 437 are then stored as part of the compressed buffer data 430 for retrieval and conveying to the display device 600 by the retrieval component 347. Again, the subtraction performed to derive each of the difference frames 337 is a relatively simple calculation that is not processor-intensive. Also, the fact that the majority of the frames compressed are the difference frames 337 results in a relatively high degree of compression while using a type of compression that is also not processor-intensive (e.g., Huffman coding). This significantly reduces the amount of data that must be retrieved for each refresh of the display 680. As a result overall, the amount of electric power required to recurringly refresh the display 680 is significantly reduced.

In embodiments in which frames of the motion video data 130 may also be visually presented on the display 680, the control routine 340 may also include a motion video decompressor 341 executable by the processor component 350 to decompress the frames of motion video data 130 employing any of a variety of types of decompression. Where the type of decompression employed is a version of MPEG, the motion video decompressor 341 may incorporate one or more of an entropy decoder 3411, an inverse quantization component 3412, an inverse discrete cosine transform (IDCT) component 3413, a motion compensator 3414 and a color space converter 3415.

Focusing on the motion video decompressor 341 of FIG. 5, and as familiar to those skilled in MPEG, the entropy decoder 3411 decodes Huffman coding (or another form of entropy coding) that may be employed during compression. Huffman coding assigns shorter bit-length descriptors to more frequently occurring data values and longer bit-length descriptors to less frequently occurring data values to reduce the number of bits required to describe the same data values. The inverse quantization component 3412 reverses, to some degree, the elimination of high frequency components that occurred in quantization during compression. The IDCT component 3413 reverses the discrete cosine transform (DCT) employed during compression to transform pixel color values to the frequency domain. The motion compensator 3414 employs the motion vectors describing the direction and distance of shifts in blocks of pixel color values to effect the results of those shifts in reconstructing frames. The color space converter 3415, if present, may be employed to convert the color space of the frames reconstructed by the other components of the motion video decompressor 341, such as from a luminance-chrominance (YUV) color space often employed in MPEG to a red-green-blue (RGB) color space often employed in driving displays.

Thus, in the operating environment depicted in FIG. 5, compressed frames of the motion video data 130 are first fully decompressed by the motion video decompressor 341 to generate uncompressed frames stored as part of the frame buffer data 330 (e.g., the current frame 332 and the preceding adjacent frame 331). From this point forward, the uncompressed frames of the motion video data 130 are handled in much the same way as the frames of a visual portion of a user interface described earlier. Multiple difference frames 337 are derived from those uncompressed frames of the motion video data 130, and at least one full frame 336 and multiple difference frames 337 representing other uncompressed frames of the motion video data 130 are compressed by the frame buffer compressor 346. The resulting at least one compressed full frame 436 and multiple compressed difference frames 437 are then stored as part of the compressed buffer data 430 for retrieval and conveying to the display device 600 by the retrieval component 347.

Turning more specifically to FIG. 6, in embodiments in which the display device 600 is not integrated into the computing device 300, the control routine 640 may include a communications component 649 executable by the processor component 650 to operate the interface 690 to transmit and receive signals via the network 999 as has been described. Among the signals received may be signals conveying the compressed buffer data 430 to the display device 600 via the network 999. As will be recognized by those skilled in the art, this communications component is selected to be operable with whatever type of interface technology is selected to implement the interface 690.

The control routine 640 includes a display buffer decompressor 646 executable by the processor component 650 to decompress a compressed full frame 436 and/or compressed difference frames 437 of the compressed buffer data 430 as received from the computing device 300 following compression by the frame buffer compressor 346. In performing such decompression, the display buffer decompressor 646 stores a resulting uncompressed full frame 336 and/or uncompressed difference frames 337, respectively, in the display buffer data 630.

As depicted, pixel color values of the difference frames 337 may be summed by the frame adder 670 with pixel color values of a preceding adjacent frame 631 to reconstruct the current frame 632. The preceding adjacent frame 631 is the most recent frame reconstructed and visually presented on the display 680, and the current frame 632 is the next frame to be reconstructed for visual presentation on the display 680. However, in other embodiments, the processor component 650 may execute a component of the control routine 640 that causes the processor component 650 to perform such summation calculations. It should be noted, however, that where the next frame to be visually displayed on the display 680 is the full frame 336, no such summation calculation is performed, and indeed, there may not yet be a preceding adjacent frame 631.

The control routine 640 includes a presentation component 648 executable by the processor component 650 to recurringly visually present the most recent current frame 632 of the display buffer data 630 on the display 680. As familiar to those skilled in the art, the refresh rate at which the presentation component 648 provides frames for visual presentation on the display 680 may be selected to match or to be a multiple of the rate at which compressed frames are received by the display device 600 from the computing device 300. Thus, in some embodiments, each one of the current frames 632 may be raster scan rendered onto the display 680 more than once.

It should be noted that in the operating environment depicted in FIG. 6, compressed frames received from the computing device 300 (whether via a network or not) are handled in the same manner, regardless of their content. Thus, there is no change in the decompression or visual presentation of frames in response to their inclusion or lack of inclusion of motion video.

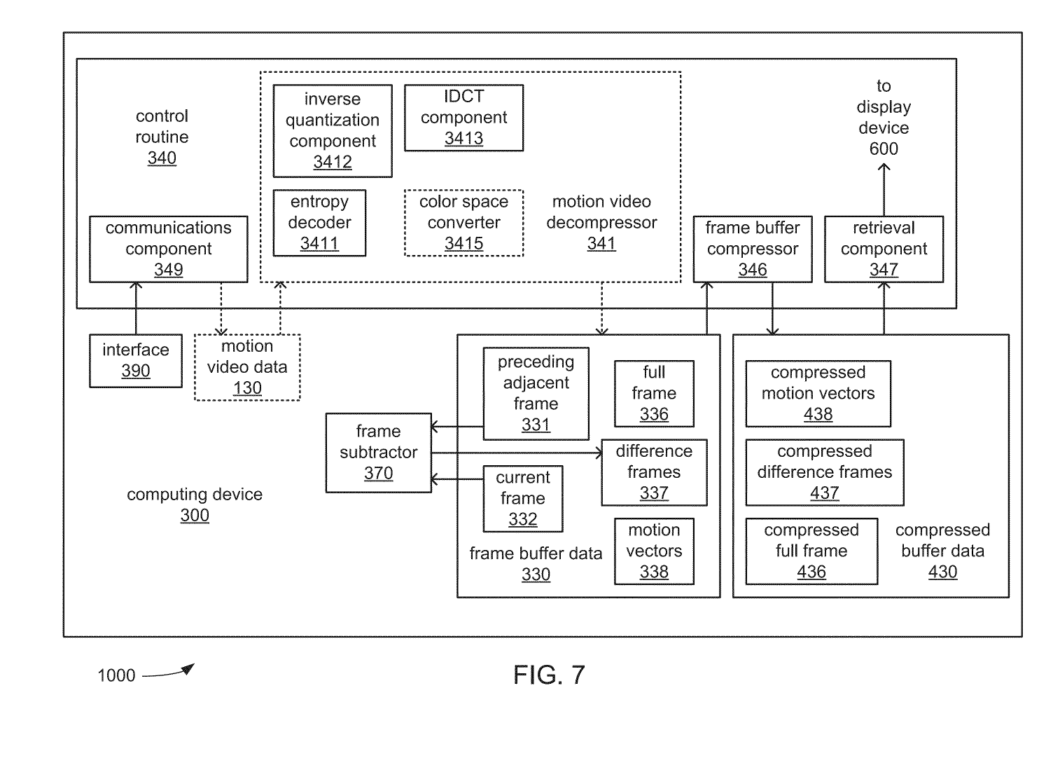

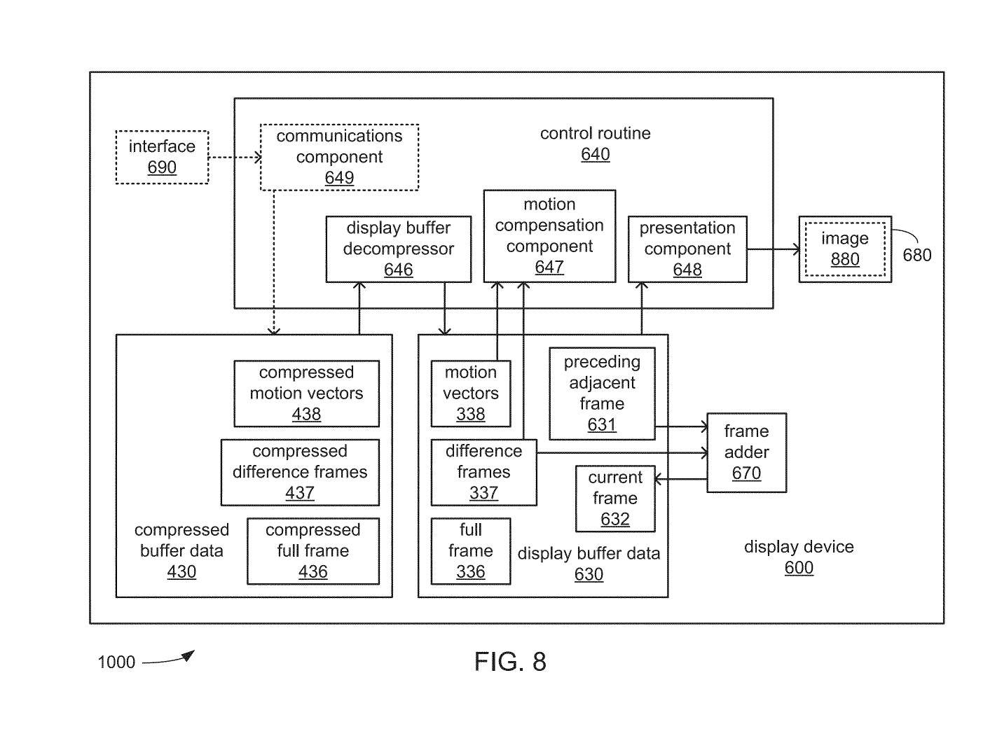

FIGS. 7 and 8 each illustrate a block diagram of a portion of an alternate embodiment of the video presentation system 1000 of either of FIG. 1 or 2 in greater detail. More specifically, FIG. 7 depicts aspects of the operating environment of an alternate embodiment of a computing device 300 in which compressed frames of the motion video data 130 are decompressed, recompressed and provided to the display device 600 somewhat differently than in the embodiment of the computing device 300 of FIG. 5. FIG. 8 depicts aspects of the operating environment of an alternate embodiment of the display device 600 in which decompression of received compressed frames that include the frames of the motion video data 130 is performed somewhat differently than in the embodiment of the display device 600 of FIG. 6. The embodiment of the display device 600 of FIG. 8 differs from its counterpart of FIG. 6 to accommodate the differences of the embodiment of the computing device 300 of FIG. 7 from its counterpart of FIG. 5.

The alternate embodiment of the video presentation system 1000 of FIGS. 7 and 8 is similar to the embodiment of the video presentation system 100 of FIGS. 5 and 6 in many ways, and thus, like reference numerals are used to refer to like elements throughout. By way of example, where the current frame 332 and the preceding adjacent frame 331 are of a visual portion of a user interface, the manner in which they are compressed and conveyed to the display device 600 and the manner in which they are decompressed and visually presented by the display device 600 are substantially similar between these two embodiments of the visual presentation system 1000. However, the manner of handling of compressed frames of motion video of the motion vide data 130 that are compressed in accordance with a version of MPEG is somewhat different.

In the embodiment of the video presentation system 1000 of FIGS. 5 and 6, compressed frames of motion video of the motion video data 130 were first fully decompressed by the motion video decompressor 341, and then recompressed by the frame buffer compressor 346 before being conveyed to the display device 600 where they were decompressed again by the display buffer decompressor 646. However, as will shortly be explained in greater detail regarding the embodiment of the video presentation system 1000 of FIGS. 7 and 8, frames of the motion video data 130 that are compressed in accordance with a version of MPEG are only partly decompressed by the motion video decompressor 341, then recompressed by the frame buffer compressor 346 before being conveyed to the display device 600 where the compression of the frame buffer compressor 346 is undone by the display buffer decompressor 341 and decompression of the original MPEG compression is finally completed.

Turning to FIG. 7, the motion video decompressor 341 incorporates the same components as its counterpart of FIG. 5, except for the motion compensator 3414. Thus, while the motion video decompressor 341 of FIG. 7 performs entropy decoding, inverse quantization and IDCT, and may also perform color space conversion as does the motion video decompressor 341 of FIG. 5, the motion video decompressor of FIG. 7 does not perform motion compensation. As those familiar with MPEG will readily recognize, motion compensation entails completing the decompression of predicted frames (P-frames) and bi-predicted frames (B-frames) by combining frames that describe pixel color values as differences from the pixel color values of at least one other frame (e.g., a type of difference frame) with indications of motion vectors that specify the direction and distance that one or more blocks of pixel color values shifted between frames. Only the intra-frames (I-frames) are fully decompressed by the motion video decompressor 341, since I-frames do not describe pixel color values by reference to the pixel color values of another frame and do not incorporate a motion vector. As a result, the motion video decompressor 341 stores the fully decompressed I-frames as full frames 336 in the frame buffer data 330, and stores the partially decompressed P-frames and B-frames as combinations of difference frames 337 and accompanying indications of motion vectors 338.

The frame buffer compressor 346 compresses full frames 336 and difference frames 337, and the retrieval component 347 recurringly retrieves the resulting compressed full frames 436 and compressed difference frame 437, respectively, for conveyance to the display device 600 in both of the embodiments of FIGS. 5 and 7. However, in FIG. 7, the frame buffer compressor 346 may also compress the indications of motion vectors 338, and the retrieval component may also retrieve and convey the resulting compressed indications of motion vectors 438 to the display device 600.

Turning to FIG. 8, the control routine 640 incorporates the display buffer decompressor 646 and the presentation component 648 as does its counterpart of FIG. 6. However, the control routine 640 of FIG. 8 additionally incorporates a motion compensation component 647. The display buffer decompressor 646 decompresses the compressed full frames 436 and compressed difference frames 437, and the presentation component 648 visually presents the most recent reconstructed frame on the display 680 in both of the embodiments of FIGS. 6 and 8. However, in FIG. 7, the display buffer decompressor 646 may also decompress the compressed indications of motion vectors 438, thereby generating indications of the motion vectors 338 in uncompressed form stored as part of the display buffer data 630. Also, the motion compensation component 647 performs the motion compensation portion of MPEG decompression that would otherwise have been performed by motion video decompressor 341. Thus, the motion compensation component 647 effectively completes the MPEG decompression of the originally compressed frames of the motion video data 130.

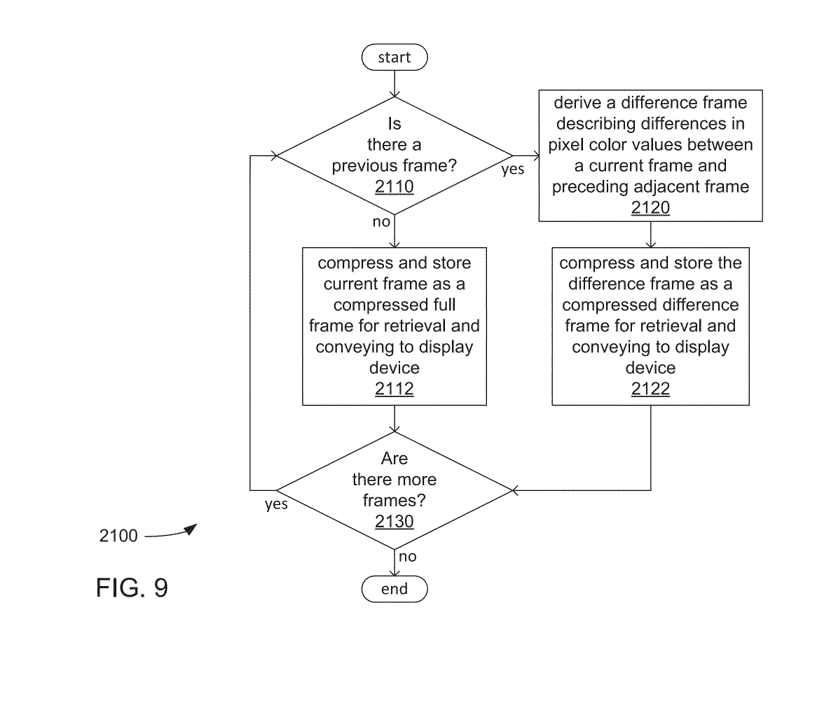

FIG. 9 illustrates one embodiment of a logic flow 2100. The logic flow 2100 may be representative of some or all of the operations executed by one or more embodiments described herein. More specifically, the logic flow 2100 may illustrate operations performed by the processor component 350 in executing at least the control routine 340, and/or performed by other component(s) of the computing device 300.

At 2110, a processor component of a computing device (e.g., the processor component 350 of the computing device 300) compresses an uncompressed current frame (e.g., the current frame 332 of the frame buffer data 330) by first checking whether there is a previous frame that may be referred to by a difference frame. As previously explained, events may occur that result in there being no previous frame to employ as a reference by a description of pixel color difference in a difference frame, such as powering on of the computing device, etc. If there is no previous frame, then at 2112, then the uncompressed current frame is compressed and stored as a compressed full frame for subsequent retrieval and conveyance to a display device (e.g., the display device 600). As also previously explained, it may be deemed desirable to compress and store the current frame in lieu of a difference frame in situations where a significant change in pixel color values of a significant proportion of pixels occurs, even where there is a previous frame available. Such a significant change of such a significant proportion of pixels may arise where there is a change in what is visually presented, such as a change between a visual presentation of motion video and a visual presentation of a visual portion of a user interface.

However, if there is a previous frame at 2110, then a difference frame describing differences in pixel color values between the uncompressed current frame and the previous frame (e.g., the preceding adjacent frame 331) is derived by subtraction of one from another at 2120. As previously explained, such subtraction may be performed by a frame subtractor implemented with digital circuitry (e.g., the frame subtractor 370) or may be performed by the processor component of the computing device. The derived difference frame is then compressed and stored as a compressed difference frame for subsequent retrieval and conveyance to the display device at 2122.

Regardless of whether a compressed full frame or a compressed difference frame has been stored at 2112 or 2122, respectively, at 2130, a check is made as to whether there are more frames to be compressed and stored in preparation for subsequent retrieval and conveyance to the display device. If there are more frames, then the check for a previous frame is repeated at 2110.

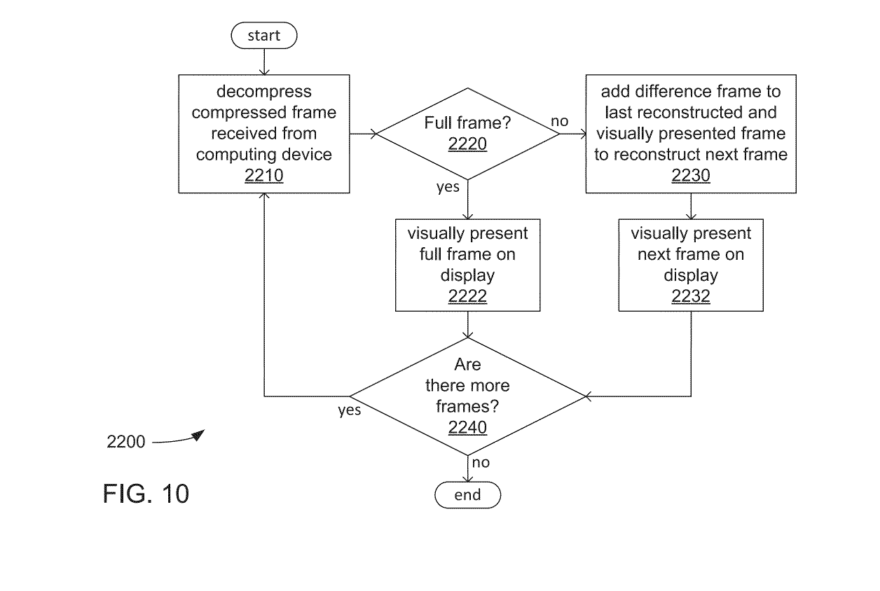

FIG. 10 illustrates one embodiment of a logic flow 2200. The logic flow 2200 may be representative of some or all of the operations executed by one or more embodiments described herein. More specifically, the logic flow 2200 may illustrate operations performed by the processor component 650 in executing at least the control routine 640, and/or performed by other component(s) of the display device 600.

At 2210, a processor component of a display device (e.g., the processor component 650 of the display device 600) decompresses a compressed frame received from a computing device (e.g., the computing device 300). As previously explained, the display device may either be incorporated into the computing device, or may be physically separate from the computing device while still being coupled to the computing device. Also, the compressed frames received from the computing device may have been compressed using Huffman coding.

At 2220, a check is made of the now decompressed frame to determine if it is a full frame (versus a difference frame). If it is a full frame, then it does not describe pixel color values in reference to another frame, and is visually presented on the display of the display device (e.g., the display 680) at 2222.

However, if at 2220, the now decompressed frame is not a full frame, then it is a difference frame and its descriptions of differences in pixel color values are summed to the last frame that was reconstructed and visually presented by the display device at 2230 to reconstruct the next frame to be visually presented. Then, the now reconstructed next frame is visually presented on the display at 2232.

Regardless of whether a full frame or a frame reconstructed with a difference frame is visually presented at 2222 or 2232, respectively, at 2240, a check is made as to whether there are more frames to be decompressed for visual presentation on the display. If there are more frames, then another compressed frame is decompressed at 2210.

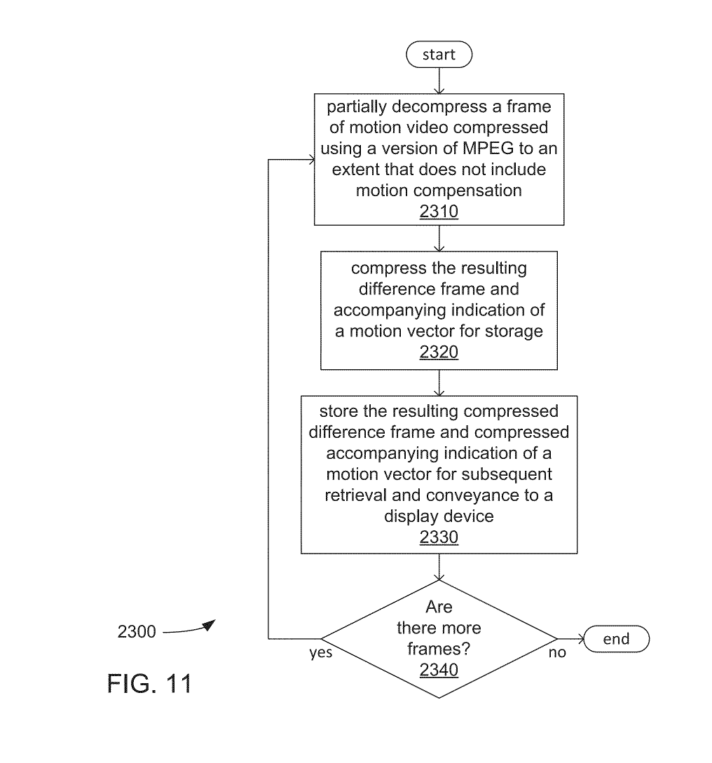

FIG. 11 illustrates one embodiment of a logic flow 2300. The logic flow 2300 may be representative of some or all of the operations executed by one or more embodiments described herein. More specifically, the logic flow 2300 may illustrate operations performed by the processor component 350 in executing at least the control routine 340, and/or performed by other component(s) of the embodiment of the computing device 300 of FIG. 7.

At 2310, a processor component of a computing device (e.g., the processor component 350 of the computing device 300) only partly decompresses a frame of motion video that has been compressed using a version of MPEG. Motion compensation in which a motion vector indicating a direction and distance by which pixel color values for a block of pixels associated with that has shifted relative to another frame is not performed. As a result, and as previously discussed, the partly decompressed frame remains a difference frame in which its pixel color values are described in reference to at least one other frame.

At 2320, this resulting difference frame and its accompanying indication of a motion vector (e.g., a difference frame 337 and indication of motion vector 338) are both compressed for storage (e.g., as a compressed difference frame 437 and a compressed indication of motion vector 438) for storage. As previously discussed, the type of compression that may be used for storage may include Huffman coding.

The resulting compressed difference frame and accompanying indication of a motion vector are so stored at 2330 in preparation for being subsequently retrieved and conveyed to a display device (e.g., the display device 600). As previously discussed, the compressed difference frame and its accompanying indication of a motion vector are conveyed together to the display device where the motion compensation step of MPEG decompression not performed by the computing device is finally performed.

2340, a check is made as to whether there are more frames of the motion video to be partly decompressed, and then compressed and stored in preparation for subsequent retrieval and conveyance to the display device. If there are more frames, then partial decompression of another frame of the motion video is performed at 2310.

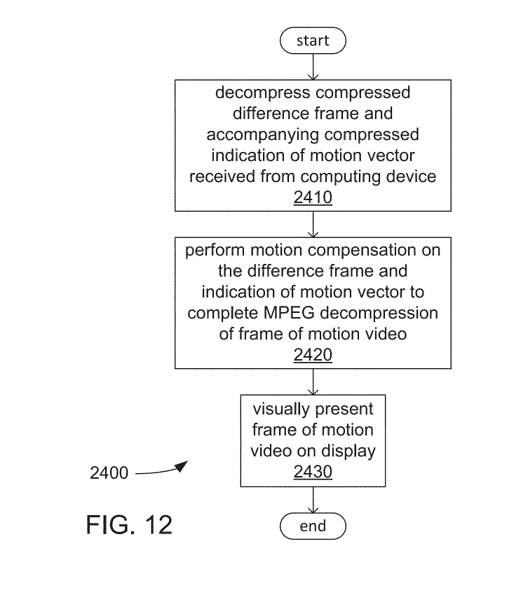

FIG. 12 illustrates one embodiment of a logic flow 2400. The logic flow 2400 may be representative of some or all of the operations executed by one or more embodiments described herein. More specifically, the logic flow 2400 may illustrate operations performed by the processor component 650 in executing at least the control routine 640, and/or performed by other component(s) of the display device 600 of FIG. 8.

At 2410, a processor component of a display device (e.g., the processor component 650 of the display device 600) decompresses both a compressed difference frame of a motion video and its accompanying compressed indication of a motion vector received from a computing device (e.g., the computing device 300). As previously explained, and as just exemplified in the logic flow 2300 above, the computing device may only partly perform MPEG decompression of frames of a motion video. The result of that partly performed decompression is combinations of difference frames and accompanying indications of motion vectors that the computing device then compresses using a different type of compression (e.g., Huffman coding) for storage, retrieval and conveyance to the display device

At 2420, the motion compensation step not performed by the computing device is performed on the combination of the resulting difference frame and indication of motion vector to essentially complete the MPEG decoding of the frame of motion video. At 2430, the now fully reconstructed frame of motion video is visually presented on the display of the display device (e.g., the display 680).

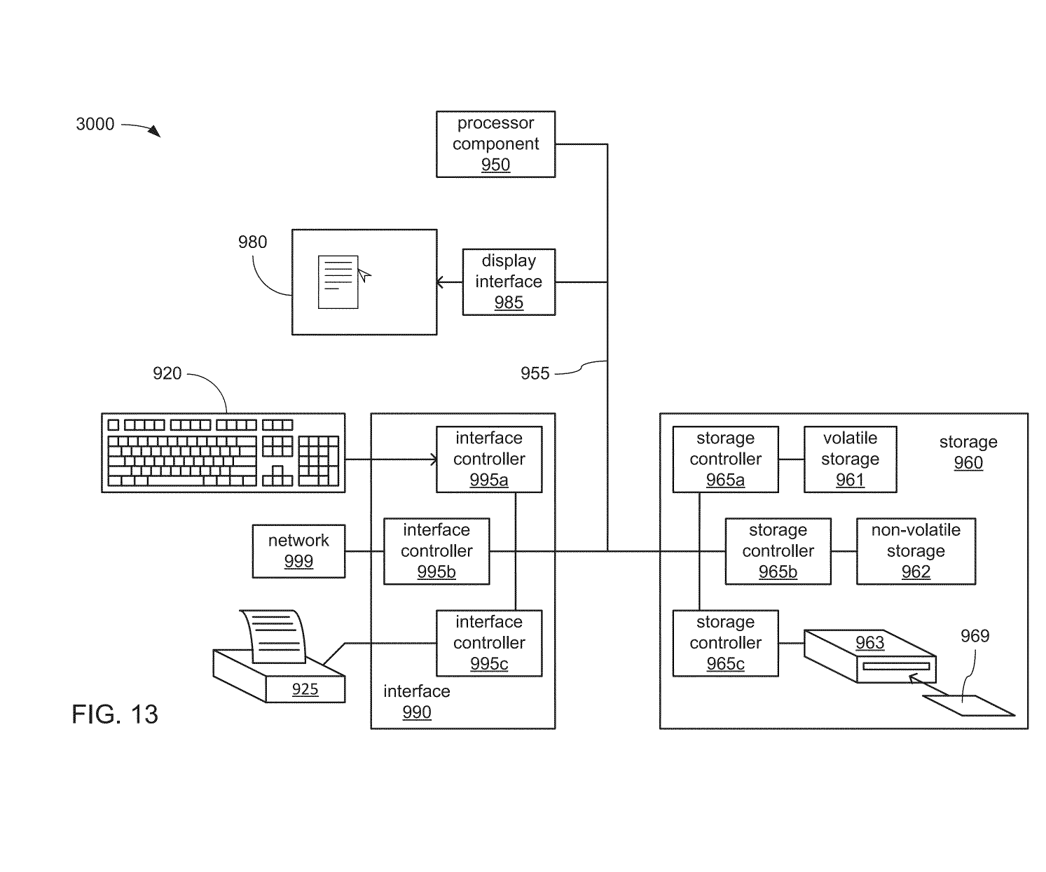

FIG. 13 illustrates an embodiment of a processing architecture 3000 suitable for implementing various embodiments as previously described. More specifically, the processing architecture 3000 (or variants thereof) may be implemented as part of one or more of the computing devices 100, 300, or 600. It should be noted that components of the processing architecture 3000 are given reference numbers in which the last two digits correspond to the last two digits of reference numbers of at least some of the components earlier depicted and described as part of the computing devices 100, 300 and 600. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device includes at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a display interface 985.

The coupling 955 includes one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor components 350 and 650) may include any of a wide variety of commercially available processors, employing any of a wide variety of technologies and implemented with one or more cores physically combined in any of a number of ways.

As previously discussed, the storage 960 (corresponding to the storages 360 and 660) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly including multiple distinct types of storage is in recognition of the commonplace use of more than one type of storage device in computing devices in which one type provides relatively rapid reading and writing capabilities enabling more rapid manipulation of data by the processor component 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (possibly corresponding to the interfaces 190, 390 or 690) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

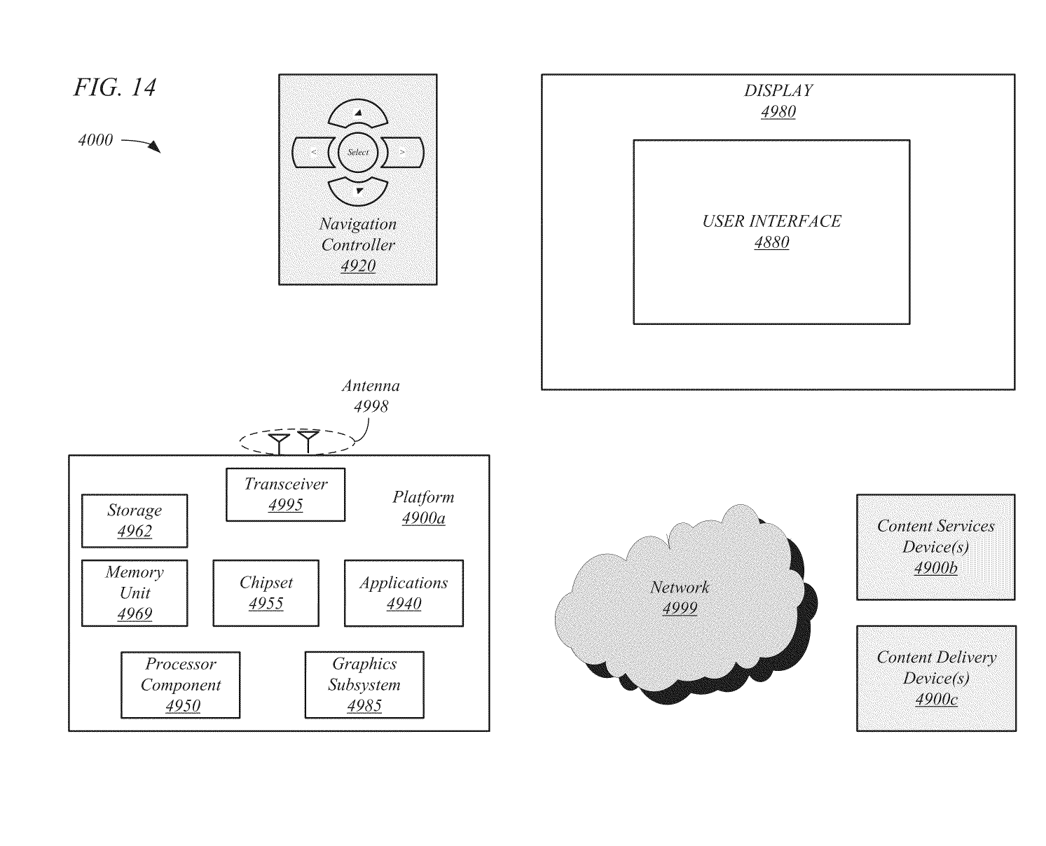

FIG. 14 illustrates an embodiment of a system 4000. In various embodiments, system 4000 may be representative of a system or architecture suitable for use with one or more embodiments described herein, such as the graphics processing system 1000; one or more of the computing devices 100, 300 or 600; and/or one or both of the logic flows 2100 or 2200. The embodiments are not limited in this respect.

As shown, system 4000 may include multiple elements. One or more elements may be implemented using one or more circuits, components, registers, processors, software subroutines, modules, or any combination thereof, as desired for a given set of design or performance constraints. Although FIG. 14 shows a limited number of elements in a certain topology by way of example, it can be appreciated that more or less elements in any suitable topology may be used in system 4000 as desired for a given implementation. The embodiments are not limited in this context.

In embodiments, system 4000 may be a media system although system 4000 is not limited to this context. For example, system 4000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 4000 includes a platform 4900a coupled to a display 4980. Platform 4900a may receive content from a content device such as content services device(s) 4900c or content delivery device(s) 4900d or other similar content sources. A navigation controller 4920 including one or more navigation features may be used to interact with, for example, platform 4900a and/or display 4980. Each of these components is described in more detail below.

In embodiments, platform 4900a may include any combination of a processor component 4950, chipset 4955, memory unit 4969, transceiver 4995, storage 4962, applications 4940, and/or graphics subsystem 4985. Chipset 4955 may provide intercommunication among processor circuit 4950, memory unit 4969, transceiver 4995, storage 4962, applications 4940, and/or graphics subsystem 4985. For example, chipset 4955 may include a storage adapter (not depicted) capable of providing intercommunication with storage 4962.

Processor component 4950 may be implemented using any processor or logic device, and may be the same as or similar to processor component 950 of FIG. 13.

Memory unit 4969 may be implemented using any machine-readable or computer-readable media capable of storing data, and may be the same as or similar to storage media 969 of FIG. 13.

Transceiver 4995 may include one or more radios capable of transmitting and receiving signals using various suitable wireless communications techniques, and may be the same as or similar to transceiver 995b in FIG. 13.

Display 4980 may include any television type monitor or display, and may be the same as or similar to display 980 in FIG. 13.

Storage 4962 may be implemented as a non-volatile storage device, and may be the same as or similar to non-volatile storage 962 in FIG. 13.

Graphics subsystem 4985 may perform processing of images such as still or video for display. Graphics subsystem 4985 may be a graphics processing unit (GPU) or a visual processing unit (VPU), for example. An analog or digital interface may be used to communicatively couple graphics subsystem 4985 and display 4980. For example, the interface may be any of a High-Definition Multimedia Interface, DisplayPort, wireless HDMI, and/or wireless HD compliant techniques. Graphics subsystem 4985 could be integrated into processor circuit 4950 or chipset 4955. Graphics subsystem 4985 could be a stand-alone card communicatively coupled to chipset 4955.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 4900b may be hosted by any national, international and/or independent service and thus accessible to platform 4900a via the Internet, for example. Content services device(s) 4900b may be coupled to platform 4900a and/or to display 4980. Platform 4900a and/or content services device(s) 4900b may be coupled to a network 4999 to communicate (e.g., send and/or receive) media information to and from network 4999. Content delivery device(s) 4900c also may be coupled to platform 4900a and/or to display 4980.

In embodiments, content services device(s) 4900b may include a cable television box, personal computer, network, telephone, Internet enabled devices or appliance capable of delivering digital information and/or content, and any other similar device capable of unidirectionally or bidirectionally communicating content between content providers and platform 4900a and/display 4980, via network 4999 or directly. It will be appreciated that the content may be communicated unidirectionally and/or bidirectionally to and from any one of the components in system 4000 and a content provider via network 4999. Examples of content may include any media information including, for example, video, music, medical and gaming information, and so forth.

Content services device(s) 4900b receives content such as cable television programming including media information, digital information, and/or other content. Examples of content providers may include any cable or satellite television or radio or Internet content providers. The provided examples are not meant to limit embodiments.

In embodiments, platform 4900a may receive control signals from navigation controller 4920 having one or more navigation features. The navigation features of navigation controller 4920 may be used to interact with a user interface 4880, for example. In embodiments, navigation controller 4920 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 4920 may be echoed on a display (e.g., display 4980) by movements of a pointer, cursor, focus ring, or other visual indicators displayed on the display. For example, under the control of software applications 4940, the navigation features located on navigation controller 4920 may be mapped to virtual navigation features displayed on user interface 4880. In embodiments, navigation controller 4920 may not be a separate component but integrated into platform 4900a and/or display 4980. Embodiments, however, are not limited to the elements or in the context shown or described herein.

In embodiments, drivers (not shown) may include technology to enable users to instantly turn on and off platform 4900a like a television with the touch of a button after initial boot-up, when enabled, for example. Program logic may allow platform 4900a to stream content to media adaptors or other content services device(s) 4900b or content delivery device(s) 4900c when the platform is turned “off.” In addition, chip set 4955 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 4000 may be integrated. For example, platform 4900a and content services device(s) 4900b may be integrated, or platform 4900a and content delivery device(s) 4900c may be integrated, or platform 4900a, content services device(s) 4900b, and content delivery device(s) 4900c may be integrated, for example. In various embodiments, platform 4900a and display 4890 may be an integrated unit. Display 4980 and content service device(s) 4900b may be integrated, or display 4980 and content delivery device(s) 4900c may be integrated, for example. These examples are not meant to limit embodiments.

In various embodiments, system 4000 may be implemented as a wireless system, a wired system, or a combination of both. When implemented as a wireless system, system 4000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 4000 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 4900a may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 14.

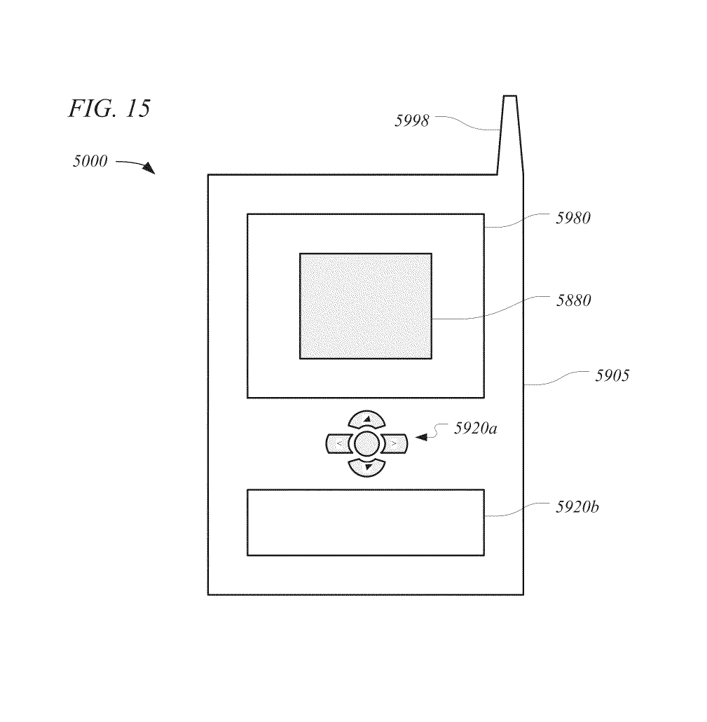

As described above, system 4000 may be embodied in varying physical styles or form factors. FIG. 15 illustrates embodiments of a small form factor device 5000 in which system 4000 may be embodied. In embodiments, for example, device 5000 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown, device 5000 may include a display 5980, a navigation controller 5920a, a user interface 5880, a housing 5905, an I/O device 5920b, and an antenna 5998. Display 5980 may include any suitable display unit for displaying information appropriate for a mobile computing device, and may be the same as or similar to display 4980 in FIG. 14. Navigation controller 5920a may include one or more navigation features which may be used to interact with user interface 5880, and may be the same as or similar to navigation controller 4920 in FIG. 14. I/O device 5920b may include any suitable I/O device for entering information into a mobile computing device. Examples for I/O device 5920b may include an alphanumeric keyboard, a numeric keypad, a touch pad, input keys, buttons, switches, rocker switches, microphones, speakers, voice recognition device and software, and so forth. Information also may be entered into device 5000 by way of a microphone. Such information may be digitized by a voice recognition device. The embodiments are not limited in this context.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

In some examples, a device to compress video frames may include a processor component, and a frame buffer compressor for execution by the processor component to compress a current frame of a series of frames as a compressed difference frame, and the compressed difference frame may include a difference frame that indicates a difference in pixel color of at least one pixel between the current frame and a preceding adjacent frame of the series of frames.

Additionally or alternatively, the frame buffer compressor may compress the preceding adjacent frame as a compressed full frame that includes the preceding frame based on a lack of a previous frame that precedes the preceding frame.

Additionally or alternatively, the frame buffer compressor to compress the preceding adjacent frame as another compressed difference frame that includes another difference frame that indicates a difference in pixel color of at least one pixel between the preceding adjacent frame and a frame of the series of frames that precedes the preceding adjacent frame.

Additionally or alternatively, the device may include a frame subtractor to subtract pixel color values of one of the current frame and the preceding adjacent frame from corresponding pixel color values of another of the current frame and the preceding adjacent frame to derive the difference frame, and the compressor may compress the difference frame to generate the compressed difference frame.

Additionally or alternatively, the frame buffer compressor may employ Huffman coding to compress the difference frame to generate the compressed difference frame.

Additionally or alternatively, the device may include a motion video decompressor for execution by the processor component to at least partially decompress frames of motion video data to generate the series of frames.

Additionally or alternatively, the motion video decompressor may employ a version of Motion Picture Experts Group (MPEG) to at least partially decompress the frames of motion video data.

Additionally or alternatively, the difference frame may be accompanied by an indication of a motion vector, and the frame buffer compressor may compress the indication of the motion vector.

Additionally or alternatively, the device may include a display device to visually present the current frame on a display, and a retrieval component for execution by the processor component to convey the compressed difference frame to the display device.

Additionally or alternatively, the display device may include another processor component, and a display buffer decompressor for execution by the another processor component to decompress the compressed difference frame to reconstruct the current frame.

Additionally or alternatively, the display device may include a frame adder to add pixel color values of the difference frame following decompression of the difference frame to pixel color values of a last reconstructed frame to reconstruct the current frame.

Additionally or alternatively, the difference frame may be accompanied by an indication of a motion vector, and the display device may include a motion compensation component for execution by the another processor component to perform motion compensation to reconstruct the current frame from the difference frame and the indication of the motion vector.

Additionally or alternatively, the device may include the display.

In some examples, a device to visually present video frames may include a processor component, a display buffer decompressor for execution by the processor component to decompress a compressed difference frame of a series of compressed frames to generate a difference frame that indicates a difference in pixel color of at least one pixel between a current frame and a preceding adjacent frame to enable reconstruction of the current frame, and a presentation component for execution by the processor component to visually present the current frame on a display.

Additionally or alternatively, the display buffer decompressor may employ Huffman coding to decompress the compressed difference frame to generate the difference frame.

Additionally or alternatively, the device may include a frame adder to add pixel color values of the difference frame to pixel color values of a last reconstructed frame to reconstruct the current frame.

Additionally or alternatively, the difference frame may be accompanied by an indication of a motion vector, and the display device may include a motion compensation component for execution by the processor component to perform motion compensation to reconstruct the current frame from the difference frame and the indication of the motion vector.

Additionally or alternatively, the display buffer decompressor may decompress a compressed full frame of the series of compressed frames to generate a full frame that indicates pixel color values without reference to another frame, the presentation component to visually present the full frame on the display based on a lack of a previous frame that precedes the full frame.

Additionally or alternatively, the device may include an interface to receive the series of compressed frames from a computing device.

Additionally or alternatively, the device may include the display.

In some examples, a computer-implemented method for compressing video frames may include compressing a current frame of a series of frames by compressing a difference frame to generate a compressed difference frame, and subtracting pixel color values of one of the current frame and a preceding adjacent frame of the series of frames from corresponding pixel color values of another of the current frame and the preceding adjacent frame to derive the difference frame.

Additionally or alternatively, the method may include compressing the preceding adjacent frame as a compressed full frame that includes the preceding frame based on a lack of a previous frame that precedes the preceding frame.

Additionally or alternatively, the method may include compressing the preceding adjacent frame by compressing another difference frame, and subtracting pixel color values of the preceding adjacent frame from a frame of the series of frames that precedes the preceding adjacent frame to derive the another difference frame.

Additionally or alternatively, the method may include employing Huffman coding to compress the difference frame to generate the compressed difference frame.

Additionally or alternatively, the method may include employing a version of Motion Picture Experts Group (MPEG) to at least partially decompress frames of motion video data to generate the series of frames.

Additionally or alternatively, the difference frame may be accompanied by an indication of a motion vector, the method may include compressing the indication of the motion vector.

Additionally or alternatively, the method may include conveying the compressed difference frame to a display device to enable the display device to visually present the current frame on a display.

Additionally or alternatively, the method may include decompressing the compressed difference frame at the display device to reconstruct the current frame.

Additionally or alternatively, the method may include adding pixel color values of the difference frame following decompression of the difference frame to pixel color values of a last reconstructed frame to reconstruct the current frame.

Additionally or alternatively, the difference frame may be accompanied by an indication of a motion vector, and the method may include performing motion compensation at the display device to reconstruct the current frame from the difference frame and the indication of the motion vector.

In some examples, at least one machine-readable storage medium may include instructions that when executed by a computing device, cause the computing device to compress a current frame of a series of frames by compressing a difference frame to generate a compressed difference frame, and subtract pixel color values of one of the current frame and a preceding adjacent frame of the series of frames from corresponding pixel color values of another of the current frame and the preceding adjacent frame to derive the difference frame.

Additionally or alternatively, the computing device may be caused to compress the preceding adjacent frame as a compressed full frame that includes the preceding frame based on a lack of a previous frame that precedes the preceding frame.

Additionally or alternatively, the computing device may be caused to compress the preceding adjacent frame by compressing another difference frame, and subtract pixel color values of the preceding adjacent frame from a frame of the series of frames that precedes the preceding adjacent frame to derive the another difference frame.

Additionally or alternatively, the computing device may be caused to employ Huffman coding to compress the difference frame to generate the compressed difference frame.

Additionally or alternatively, the computing device may be caused to employ a version of Motion Picture Experts Group (MPEG) to at least partially decompress frames of motion video data to generate the series of frames.

Additionally or alternatively, the difference frame may be accompanied by an indication of a motion vector, and the computing device may be caused to compress the indication of the motion vector.

Additionally or alternatively, the computing device may be caused to convey the compressed difference frame to a display device to enable the display device to visually present the current frame on a display.

Additionally or alternatively, the computing device may be caused to decompress the compressed difference frame at the display device to reconstruct the current frame.

Additionally or alternatively, the computing device may be caused to add pixel color values of the difference frame following decompression of the difference frame to pixel color values of a last reconstructed frame to reconstruct the current frame.

Additionally or alternatively, the difference frame may be accompanied by an indication of a motion vector, and the computing device may be caused to perform motion compensation at the display device to reconstruct the current frame from the difference frame and the indication of the motion vector.

In some examples, a computer-implemented method for visually presenting video frames may include decompressing a compressed difference frame of a series of compressed frames to generate a difference frame indicating a difference in pixel color of at least one pixel between a current frame and a preceding adjacent frame to enable reconstruction of the current frame, and visually presenting the current frame on a display.

Additionally or alternatively, the method may include employing Huffman coding to decompress the compressed difference frame to generate the difference frame.

Additionally or alternatively, the method may include adding pixel color values of the difference frame to pixel color values of a last reconstructed frame to reconstruct the current frame.

Additionally or alternatively, the difference frame may be accompanied by an indication of a motion vector, and the method may include performing motion compensation to reconstruct the current frame from the difference frame and the indication of the motion vector.

Additionally or alternatively, the method may include decompressing a compressed full frame of the series of compressed frames to generate a full frame that indicates pixel color values without reference to another frame, and visually presenting the full frame on the display based on a lack of a previous frame that precedes the full frame.

Additionally or alternatively, the method may include receiving the series of compressed frames from a computing device.

In some examples, at least one machine-readable storage medium may include instructions that when executed by a computing device, cause the computing device to decompress a compressed difference frame of a series of compressed frames to generate a difference frame indicating a difference in pixel color of at least one pixel between a current frame and a preceding adjacent frame to enable reconstruction of the current frame, and visually present the current frame on a display.

Additionally or alternatively, the computing device may be caused to employ Huffman coding to decompress the compressed difference frame to generate the difference frame.

Additionally or alternatively, the computing device may be caused to add pixel color values of the difference frame to pixel color values of a last reconstructed frame to reconstruct the current frame.

Additionally or alternatively, the difference frame may be accompanied by an indication of a motion vector, and the computing device caused to perform motion compensation to reconstruct the current frame from the difference frame and the indication of the motion vector.

Additionally or alternatively, the computing device may be caused to decompress a compressed full frame of the series of compressed frames to generate a full frame that indicates pixel color values without reference to another frame, and visually present the full frame on the display based on a lack of a previous frame that precedes the full frame.

Additionally or alternatively, the computing device may caused to receive the series of compressed frames from a computing device.

In some embodiments, at least one machine-readable storage medium may include instructions that when executed by a computing device, cause the computing device to perform any of the above.

In some embodiments, an device to compress and/or visually present video frames may include means for performing any of the above.

1-25. (canceled)

26. A device to compress video frames comprising:
a processor component;
a storage communicatively coupled to the processor component; and
a frame buffer compressor for execution by the processor component to compress a current frame of a series of frames as a compressed difference frame and store the compressed difference frame in the storage, the compressed difference frame comprising a difference frame that indicates a difference in pixel color of at least one pixel between the current frame and a preceding adjacent frame of the series of frames.

27. The device of claim 26, the frame buffer compressor to compress the preceding adjacent frame as a compressed full frame comprising the preceding frame based on a lack of a previous frame that precedes the preceding frame, and store the compressed full frame in the storage.

28. The device of claim 26, the frame buffer compressor to compress the preceding adjacent frame as another compressed difference frame comprising another difference frame that indicates a difference in pixel color of at least one pixel between the preceding adjacent frame and a frame of the series of frames that precedes the preceding adjacent frame.

29. The device of claim 26, comprising a frame subtractor to subtract pixel color values of one of the current frame and the preceding adjacent frame from corresponding pixel color values of another of the current frame and the preceding adjacent frame to derive the difference frame, the compressor to compress the difference frame to generate the compressed difference frame.

30. The device of claim 26, comprising a motion video decompressor for execution by the processor component to at least partially decompress frames of motion video data to generate the series of frames.

31. The device of claim 26, comprising:
a display device to visually present the current frame on a display; and
a retrieval component for execution by the processor component to retrieve the compressed difference frame from the storage and convey the compressed difference frame to the display device.

32. The device of claim 31, the display device comprising:
another processor component; and
a display buffer decompressor for execution by the another processor component to decompress the compressed difference frame to reconstruct the current frame.

33. The device of claim 32, the difference frame accompanied by an indication of a motion vector, and the display device comprising a motion compensation component for execution by the another processor component to perform motion compensation to reconstruct the current frame from the difference frame and the indication of the motion vector.

34. A device to visually present video frames comprising:
a processor component;
a storage communicatively coupled to the processor component;
a display buffer decompressor for execution by the processor component to retrieve a compressed difference frame of a series of compressed frames from the storage and decompress the compressed difference frame to generate a difference frame that indicates a difference in pixel color of at least one pixel between a current frame and a preceding adjacent frame to enable reconstruction of the current frame; and
a presentation component for execution by the processor component to visually present the current frame on a display.

35. The device of claim 34, the difference frame accompanied by an indication of a motion vector, and the display device comprising a motion compensation component for execution by the processor component to perform motion compensation to reconstruct the current frame from the difference frame and the indication of the motion vector.

36. The device of claim 34, the display buffer decompressor to retrieve a compressed full frame of the series of compressed frames from the storage and to decompress the compressed full frame to generate a full frame that indicates pixel color values without reference to another frame, the presentation component to visually present the full frame on the display based on a lack of a previous frame that precedes the full frame.

37. The device of claim 34, comprising:
an interface to receive the series of compressed frames from a computing device; and
a communications component to store the series of compressed frames in the storage.

38. The device of claim 34, comprising the display.

39. A computer-implemented method for compressing video frames comprising:
compressing a current frame of a series of frames by compressing a difference frame to generate a compressed difference frame;
subtracting pixel color values of one of the current frame and a preceding adjacent frame of the series of frames from corresponding pixel color values of another of the current frame and the preceding adjacent frame to derive the difference frame; and
storing the compressed difference frame in a compressed frame buffer.

40. The computer-implemented method of claim 39, the method comprising:
compressing the preceding adjacent frame as a compressed full frame comprising the preceding frame based on a lack of a previous frame that precedes the preceding frame; and
storing the compressed full frame in the compressed frame buffer.

41. The computer-implemented method of claim 39, the method comprising:
compressing the preceding adjacent frame by compressing another difference frame; and
subtracting pixel color values of the preceding adjacent frame from a frame of the series of frames that precedes the preceding adjacent frame to derive the another difference frame.

42. The computer-implemented method of claim 39, the method comprising employing a version of Motion Picture Experts Group (MPEG) to at least partially decompress frames of motion video data to generate the series of frames.

43. The computer-implemented method of claim 42, the difference frame accompanied by an indication of a motion vector, the method comprising compressing the indication of the motion vector.

44. The computer-implemented method of claim 39, the method comprising:
retrieving the compressed difference frame from the compressed frame buffer; and
conveying the compressed difference frame to a display device to enable the display device to visually present the current frame on a display.

45. At least one machine-readable storage medium comprising instructions that when executed by a computing device, cause the computing device to:
compress a current frame of a series of frames by compressing a difference frame to generate a compressed difference frame; and
subtract pixel color values of one of the current frame and a preceding adjacent frame of the series of frames from corresponding pixel color values of another of the current frame and the preceding adjacent frame to derive the difference frame.

46. The at least one machine-readable storage medium of claim 45, the computing device caused to compress the preceding adjacent frame as a compressed full frame comprising the preceding frame based on a lack of a previous frame that precedes the preceding frame.

47. The at least one machine-readable storage medium of claim 45, the computing device caused to:
compress the preceding adjacent frame by compressing another difference frame; and
subtract pixel color values of the preceding adjacent frame from a frame of the series of frames that precedes the preceding adjacent frame to derive the another difference frame.

48. The at least one machine-readable storage medium of claim 45, the computing device caused to convey the compressed difference frame to a display device to enable the display device to visually present the current frame on a display.

49. The at least one machine-readable storage medium of claim 48, the computing device caused to decompress the compressed difference frame at the display device to reconstruct the current frame.

50. The at least one machine-readable storage medium of claim 49 the computing device caused to add pixel color values of the difference frame following decompression of the difference frame to pixel color values of a last reconstructed frame to reconstruct the current frame.
